(19) United States
(12) Patent Application Publication
(10) Pub. No.: US 2025/0138311 A1
(43) Pub. Date: May 1, 2025

(54) BACKLIGHT DEVICE AND ASSOCIATED IMAGE GENERATION DEVICE, HEAD-UP DISPLAY, AND MANUFACTURING METHOD

(71) Applicant: VALEO COMFORT AND DRIVING ASSISTANCE, Créteil (FR)

(72) Inventors: Ayoub Ben Nachouane, Créteil (FR); Alexis Kleckner, Créteil (FR); Arnaud Husson, Créteil (FR); Delphine Le Guyader, Créteil (FR)

(73) Assignee: VALEO COMFORT AND DRIVING ASSISTANCE, Créteil (FR)

(21) Appl. No.: 18/836,641

(22) PCT Filed: Jan. 20, 2023
(86) PCT No.: PCT/EP2023/051452

§ 371 Date: Aug. 7, 2024

(30) Foreign Application Priority Data
Feb. 8, 2022 (FR) FR2201106

(51) Int. Cl. G02B 27/01

(52) U.S. Cl. CPC G02B 27/0101

(57) ABSTRACT

A back-lighting device comprises a light source configured to emit a source beam, a reflector configured to reflect at least a part of the source beam into a reflected beam, an integrally formed component comprising, on a first side, a reflective polarizer and, on a second side opposite the first side, an optical diffuser, said component being configured to receive and transmit at least a part of the reflected beam, characterized in that the first side of the component is placed facing the light source. An image-generating device, a head-up display and a process for manufacturing a component for the back-lighting device are disclosed herein.

The present invention relates in general to the field of displays.

It more particularly relates to a back-lighting device, used for example in a head-up display for a motor vehicle, and to an associated image-generating device, head-up display and manufacturing process.

Typically, a so-called “head-up” display forms a virtual image in the field of view of a motor-vehicle driver. The latter is thus able to view information relating to the operation of the vehicle, relating to a traffic lane ahead of the vehicle and so on without having to avert her or his gaze from this traffic lane to do so. Specifically, the virtual image, containing the information to be displayed, is then superposed visually on the environment ahead of the vehicle.

Generally, a so-called “head-up” display comprises, inside a housing, an image-generating device from which a source light beam emerges and a projecting optical system that is configured to project an image generated by the image-generating device toward the exterior, via the windshield for example, so as to form the aforementioned virtual image.

Head-up displays for motor vehicles using a liquid-crystal display (LCD) in their image-generating device are often exposed to two types of thermal stresses that cause the screen to heat up: one of these stresses is associated with the light source of the head-up display, and the other with concentration of solar rays on the display.

Preservation of such LCDs, which are sensitive components, requires the parts of the head-up display to be suitably assembled to decrease this heating.

In this context, the present invention provides a back-lighting device comprising:
a light source configured to emit a source beam,
a reflector configured to reflect at least a part of the source beam into a reflected beam,
an integrally formed component comprising, on a first side, a reflective polarizer and, on a second side opposite the first side, an optical diffuser, said component being configured to receive and transmit at least a part of the reflected beam,
characterized in that the first side of the component is placed facing the light source.

Positioning the first side of the component facing the light source makes it possible to improve recycling of light inside the back-lighting device. Specifically, if some of the source beam does not have the polarization transmitted by the reflective polarizer, it is reflected by the reflective polarizer and may be re-intercepted by the reflector and again reflected in the direction of the component. Thus, transmission of light by the back-lighting device is improved.

Furthermore, when exterior light (sunlight for example) penetrates into the head-up display and reaches the component, said light does not reach the reflective polarizer directly, this preventing stray light from appearing in the field of view of an observer.

In one embodiment, the optical diffuser is engraved in a transparent substrate bearing the reflective polarizer.

As explained below, the component may comprise a substrate with a first side bearing the reflective polarizer and a second side opposite the first side and in which the diffuser is formed by engraving.

For example, the engraving is laser engraving.

In one embodiment, the reflective polarizer is laminated onto the optical diffuser.

For example, the optical diffuser produces diffusion of light of elliptical-Gaussian type.

One of the aspects of the invention also relates to an image-generating device comprising a back-lighting device such as described above, and further comprising a liquid-crystal display placed downstream of the reflector on the propagation path of the light, the liquid-crystal display comprising a liquid-crystal matrix interposed between an upstream polarizer and a downstream polarizer, said upstream polarizer being capable of selectively transmitting a light component having a given upstream polarization.

In one embodiment, the reflective polarizer is configured to reflect a light component having a polarization orthogonal to said upstream polarization.

In one embodiment, the reflector has a principal axis parallel to a principal direction of the source beam and the component is orthogonal to the principal axis of the reflector.

In one embodiment, the liquid-crystal display is inclined with respect to the principal direction of the source beam and the component is positioned parallel to the liquid-crystal display.

One of the aspects of the invention also relates to a head-up display comprising an image-generating device such as described above and further comprising a projecting optical system able of steering a light beam generated by the image-generating device in the direction of a partially transparent plate.

Lastly, one aspect of the invention relates to a process for manufacturing a component for a back-lighting device from a substrate provided with a reflective polarizer on a first side and having a second side opposite the first side, comprising a step of forming an optical diffuser by engraving in the second side of the substrate.

For example, the step of forming the optical diffuser is a step of laser engraving.

Of course, the various features, variants and embodiments of the invention may be associated with one another in various combinations provided that they are not mutually exclusive or incompatible.

In addition, various other features of the invention will become apparent from the accompanying description, which is given with reference to the drawings, which illustrate non-limiting embodiments of the invention and in which:

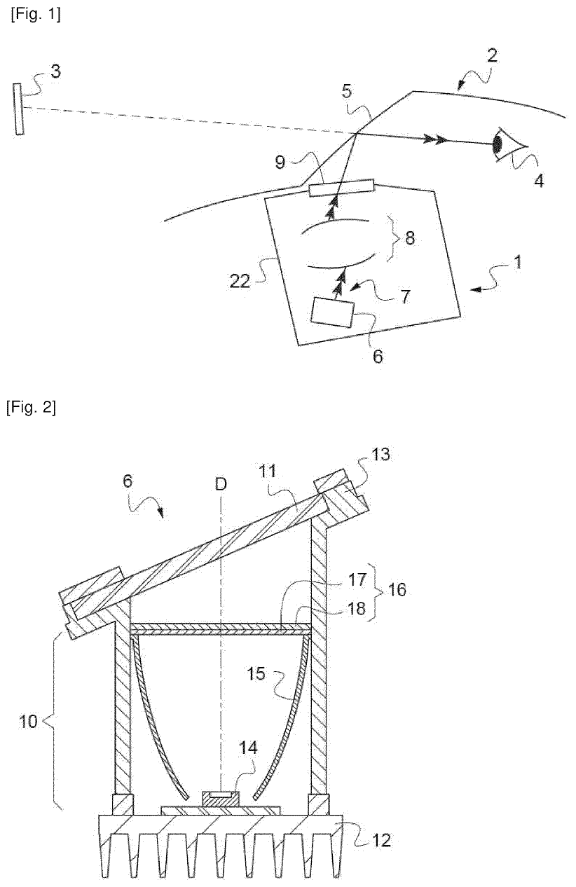

FIG. 1 is a schematic view showing integration of a head-up display according to the invention into a motor vehicle.

FIG. 2 shows a first embodiment of a back-lighting device according to the invention.

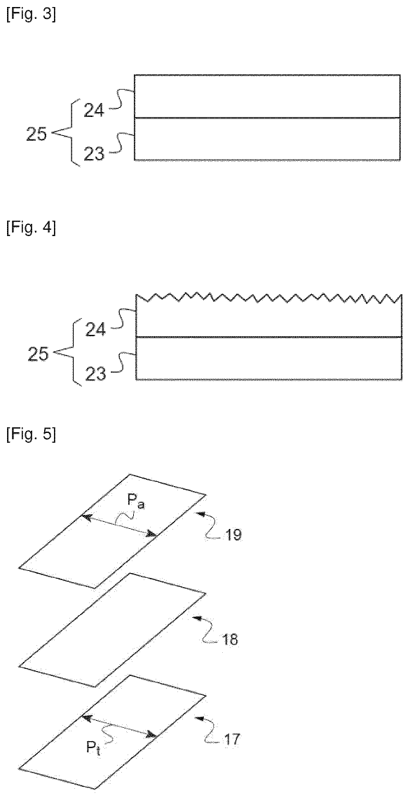

FIG. 3 shows a substrate provided with a reflective polarizer before a step of forming an optical diffuser by laser engraving.

FIG. 4 shows the substrate of FIG. 3 after a step of forming an optical diffuser by laser engraving.

FIG. 5 schematically shows the arrangement of certain components of an image-generating device according to the invention.

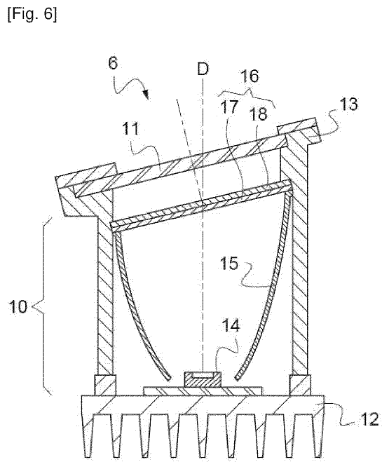

FIG. 6 shows a second embodiment of a back-lighting device according to the invention.

It will be noted that in these figures structural and/or functional elements common to the various variants may have the same reference signs.

FIG. 1 schematically shows the main elements of a head-up display 1 intended, for example, to be fitted in a vehicle 2, in particular a motor vehicle.

The display 1 of FIG. 1 is configured to project a virtual image 3 into the field of view of a driver 4 of the vehicle 2, such that the driver 4 may see this virtual image 3 and any information that it contains without having to avert her or his gaze.

To this end, the display 1 comprises a partially transparent plate 5 placed in the field of view of the driver 4, an image-generating device 6 configured to generate an image light beam 7 and a projecting optical system 8 configured to steer, in the direction of said partially transparent plate 5, the image light beam 7 generated by the image-generating device 6 after passing through a transparent window 9. The light beam steered in the direction of the partially transparent plate 5 is partly reflected by the partially transparent plate 5 in the direction of the driver 4 and thus produces the virtual image 3.

The partially transparent plate 5 is here merged with the windscreen of the vehicle 2. In other words, it is the windscreen of the vehicle 3 that acts as the partially transparent plate 5 for the purposes of the head-up display 1.

As may be seen in FIG. 1, the image-generating device 6 and the projecting optical system 8 are here placed in a housing 22, an aperture of which is closed by the transparent window 9 mentioned above.

A first embodiment of the image-generating device 6 according to the invention is illustrated in FIG. 2. The image-generating device 6 comprises a back-lighting device 10, a liquid-crystal display 11 covering the back-lighting device 10, a first heat sink 12 and a second heat sink 13.

The back-lighting device 10 comprises a light source 14 in the form of an light-emotting diodes matrix, a reflector 15 and an optical component 16. The light source 14 is configured to emit a source beam that is divergent around a principal direction D. The reflector 15 receives at least of a part of the source beam and reflects at least a part thereof into a reflected beam reflected in the direction of the optical component 16. The reflected beam is here collimated. The optical component 16 receives at least a part of the reflected beam and transmits at least a part thereof in a diffused beam toward the liquid-crystal display 11. The diffused beam illuminates the liquid-crystal display 11 so that the liquid-crystal display 11 may allow at least a part of the diffused beam to pass to form the image light beam 7.

The optical component 16 is a dedicated component that is integrally formed and that comprises a reflective polarizer 17 on a first side and an optical diffuser 18 on a second side opposite the first side. By integrally formed, what is meant is that the optical component 16 consists of a single part. By reflective polarizer, what is meant is a polarizer operating in reflection, i.e. that reflects a determined polarization component Pd and transmits the orthogonal polarization component. By optical diffuser, what is meant is an optical element that causes angular spreading of incident light.

The first side is positioned facing the reflector 15, which is on the same side as the light source 14. This configuration makes it possible to improve recycling of light inside the back-lighting device 10. Specifically, if some of the source beam does not have the polarization transmitted by the reflective polarizer, it is reflected by the reflective polarizer 17 and may be re-intercepted by the reflector 15, then reflected again in the direction of the optical component 16.

One of the advantages of the optical component 16 being integrally formed is that it limits reflections between the reflective polarizer 17 and the optical diffuser 18. The limitation of these reflections makes it possible to improve the contrast perceived directly on the liquid-crystal display 11.

For example, the optical component 16 is obtained using the following process:
preparing an intermediate part comprising a substrate provided with a reflective polarizer on a first side; the reflective polarizer may be made of plastic, for example of PVA-TAC-acrylic, and makes it possible to transmit light incident on its surface with a given polarization and to reflect light incident with a polarization orthogonal to the given polarization.
engraving patterns on the second side of the substrate (opposite the first side), for example by laser engraving, in order to form the optical diffuser 18 on this side; a diffusing structure may for example be printed on the back side (i.e. the side not directly receiving incident light) of a reflective polarizer made of a plastic, of polycarbonate type, by means of laser engraving, and for example by femtosecond laser patterning; the diffusing structure corresponds to a graining distributed over the back side so as to diffuse the light with a given diffusion distribution.

FIG. 3 shows a substrate 25 provided on a first side 23 with a reflective polarizer. The substrate 25 has a transparent layer 24, here made of polycarbonate, defining a second side opposite the first side 23. It is proposed here to apply laser engraving to this second side in order to form an optical diffuser.

FIG. 4 shows the substrate 25 of FIG. 3 after laser engraving has been applied to the second side defined by the transparent layer 24. The structured profile of the second side may be observed following the laser engraving. This structured profile imparts an additional diffusion function to the substrate provided with the reflective polarizer.

In a variant, the reflective polarizer 17 is laminated onto the optical diffuser 18 using a transparent optical adhesive. In this case, the optical diffuser 18 may be made of an injection-molded plastic, such as polycarbonate. The thickness of the optical diffuser 18 in the optical component 16 may be between 0.2 mm and 1 mm, and is preferably equal to 0.5 mm. Alternatively, the optical diffuser 18 may be a plastic film, for example one made of polycarbonate. The thickness of the film may be between 0.1 mm and 0.25 mm, and is preferably equal to 0.125 mm. Preferably, the material of the optical diffuser 18 has a deflection temperature greater than or equal to 120° C. with a load equal to 1.8 MPa, and greater than or equal to 130° C. with a load equal to 0.45 MPa.

In order to guarantee the quality of the lamination of the reflective polarizer 17 onto the optical diffuser 18, the latter is preferably made of plastic and is heated to a temperature between 30° C. and 60° C. This procedure makes it possible to reduce mechanical stresses inside the optical diffuser 18 and to guarantee better adhesion to the reflective polarizer.

For example, the thickness of the reflective polarizer 17 in the optical component 16 is less than or equal to 0.15 mm. Preferably, the thickness of the reflective polarizer 17 in the optical component 16 is equal to 0.075 mm.

Preferably, the reflective polarizer 17 is able to operate at temperatures greater than or equal to 105° C.

The optical diffuser 18 is defined by an indicatrix of diffusion with a maximum amplitude in a principal direction, and for example, angular widths in certain directions. For example, the type of diffusion produced by the optical diffuser 18 is of elliptical-Gaussian type. For example, the full width at half maximum of diffusion in the direction of the length of the liquid-crystal display 11 is 30 degrees and the full width at half maximum of diffusion in the direction of the width of the liquid-crystal display 11 is 20 degrees.

The liquid-crystal display 11 comprises a liquid-crystal matrix interposed between an upstream polarizer 19 and a downstream polarizer 20, the upstream polarizer 19 being located facing the optical component 16. The upstream polarizer 19 is configured to selectively transmit a light component having an upstream polarization Pa to the liquid-crystal matrix. Suitable activation of certain elements of the liquid-crystal matrix selectively allows passage of the light received from the upstream polarizer 19 via modification of the polarization thereof through the elements of the liquid-crystal matrix and transmission or not through the downstream polarizer 20.

The determined polarization Pd reflected by the reflective polarizer 17 is adjusted to be orthogonal to the upstream polarization Pa. In other words, the polarization of the light Pt transmitted by the reflective polarizer 17 is aligned with the polarization direction transmitted by the upstream polarizer 19 of the liquid-crystal display 11. FIG. 5 schematically illustrates this adjustment.

Thus, if the optical diffuser 18 is chosen so that it minimizes disturbance of the polarization of the light that it receives, the diffused beam will have a polarization that will be transmitted by the upstream polarizer 19 of the liquid-crystal display 11 and pass through the latter. In this way, the absorption of the diffused beam in the liquid-crystal display 11 is reduced while its transmission is improved, this limiting heating of the liquid-crystal display 11.

In this first embodiment, the reflector 15 has a constant height in the direction defined by the principal direction of emission of the light source 14, and a principal axis parallel to the principal direction of emission D of the light source 14.

For example, the reflector 15 is made of plastic with a metallization layer applied to the interior walls of the reflector 15. Preferably, the material of the reflector 15 has a deflection temperature greater than or equal to 120° C. with a load equal to 1.8 MPa and greater than or equal to 130° C. with a load equal to 0.45 MPa. This makes it possible to preserve the mechanical and thermal properties of the reflector over the entire operating range of the image-generating device 6—for example between −40° C. and 105° C. Aluminum or silver may be used for the metallization.

For example, the reflection coefficient of the reflector 15 is greater than or equal to 60%, and preferably greater than or equal to 80%. This parameter makes it possible to reduce light losses due to absorption and improves the uniformity of the virtual image 3.

The geometry of the reflector 15 may be optimized in order to improve the recycling efficiency of the reflective polarizer 17. Preferably, the shape of the reflector 15 is tapered, with the narrowest part positioned closer to the light source 14. For example, the reflector 15 may have walls the inclination of which allows the reflecting surface area seen by the reflective polarizer 17 to be maximized. Also, the curvature of the walls of the reflector 15 may be optimized to improve the collimation of the source beam.

In this first embodiment, the optical component 16 is orthogonal to the principal axis of the reflector.

Moreover, the normal direction of the liquid-crystal display 11 is inclined with respect to the direction of the principal axis of the reflector 15.

FIG. 6 illustrates a second embodiment of the back-lighting device 6 according to the invention.

As in the first embodiment, the normal direction of the liquid-crystal display 11 is inclined with respect to the direction of the principal axis of the reflector 15.

In this second embodiment, the normal direction of the optical component 16 is also inclined with respect to the direction of the principal axis of the reflector 15. For example, the inclination is between 12 degrees and 24 degrees. Preferably, the inclination is greater than 13 degrees.

For example, the optical component 16 is parallel to the liquid-crystal display 11.

The geometry of the reflector 15 is then tailored to this configuration in order to prevent the optical characteristics of the perceived virtual image 3, such as the contrast, luminance and uniformity of the virtual image 3, from being degraded. As illustrated in FIG. 6, the reflector still has a principal axis parallel to the principal direction of emission of the light source but is asymmetrical. For example, the edges of the reflector 15 intercept an imaginary surface that is inclined by an angle of inclination with respect to a plane orthogonal to the principal axis of the reflector 15. For example, the imaginary surface is parallel to the liquid-crystal display 11.

1. A back-lighting device comprising:
a light source configured to emit a source beam;
a reflector configured to reflect at least a part of the source beam into a reflected beam; and
an integrally formed component comprising, on a first side, a reflective polarizer and, on a second side opposite the first side, an optical diffuser, said component being configured to receive and transmit at least a part of the reflected beam,
wherein the first side of the component is placed facing the light source.

2. The back-lighting device as claimed in claim 1, wherein the component comprises a substrate with a first side bearing the reflective polarizer and a second side opposite the first side and in which the diffuser is formed by engraving.

3. The back-lighting device as claimed in claim 2, wherein the engraving is laser engraving.

4. The back-lighting device as claimed in claim 1, wherein the reflective polarizer is laminated onto the optical diffuser.

5. The back-lighting device as claimed in claim 1, wherein the optical diffuser produces diffusion of light of elliptical-Gaussian type.

6. An image-generating device comprising:
a back-lighting device as claimed in claim 1; and
a liquid-crystal display placed downstream of the reflector on the propagation path of the light, the liquid-crystal display comprising a liquid-crystal matrix interposed between an upstream polarizer and a downstream polarizer,
said upstream polarizer being capable of selectively transmitting a light component having a given upstream polarization.

7. The image-generating device as claimed in claim 6, wherein the reflective polarizer is configured to reflect a light component having a polarization orthogonal to said upstream polarization.

8. The image-generating device as claimed in claim 6, wherein the reflector has a principal axis parallel to a principal direction of the source beam and in that the component is orthogonal to the principal axis of the reflector.

9. The image-generating device as claimed in claim 6, wherein,
the liquid-crystal display is inclined with respect to the principal direction of the source beam,
the component is positioned parallel to the liquid crystal display.

10. A head-up display comprising an image-generating device as claimed in claim 6, and further comprising a projecting optical system capable of steering a light beam generated by the image-generating device in the direction of a partially transparent plate.

11. A process for manufacturing a component for a back-lighting device from a substrate provided with a reflective polarizer on a first side and having a second side opposite the first side, comprising a step of forming an optical diffuser by engraving in the second side of the substrate.

12. The manufacturing process as claimed in claim 11, wherein the step of forming the optical diffuser is a step of laser engraving.
